(19) United States
(12) Patent Application Publication
(10) Pub. No.: US 2013/0327904 A1
(43) Pub. Date: Dec. 12, 2013

(54) Slotted Handheld Electronic Device Support

(71) Applicant: Albert Christal, Chicago, IL (US)

(72) Inventor: Albert Christal, Chicago, IL (US)

(21) Appl. No.: 13/914,889

(22) Filed: Jun. 11, 2013

Related U.S. Application Data
(60) Provisional application No. 61/658,499, filed on Jun. 12, 2012.

(51) Int. Cl. F16M 11/00

(52) U.S. Cl. CPC F16M 11/00
USPC 248/176.1

(57) ABSTRACT

Provided is an electronic device support having a body portion and a slotted support for the device such that it stands in a largely upright configuration for ready visualization of the device screen and for ease of access. The support is utilized as a structural storage means to support a tablet, cellular phone, or similar electronic device having a substantially rectangular shape such that the user can view the screen and store the device in an upstanding configuration without handling the device or resting it against a support wall. Several embodiments are provided, which include a slotted support and a body region that is weighted to prevent tipping while supporting a small, medium, or large handheld electronic device. The slotted support further comprises an adjustment element to increase or decrease the size of the slot to accommodate different sized electronic devices.

### CROSS REFERENCE TO RELATED APPLICATION

This application claims the benefit of U.S. Provisional Application No. 61/658,499 filed on Jun. 13, 2012, entitled “Cell Phone Shelf.” The above identified patent application is herein incorporated by reference in its entirety to provide continuity of disclosure.

### BACKGROUND OF THE INVENTION

1. Field of the Invention

The present invention relates to supports and shelves for electronic devices. More specifically, the present invention pertains to a slotted cell phone or tablet support for use along a horizontal or vertical support surface.

Modern handheld electronic devices, such as smartphone and tablet devices, are comprised of a thin, shell-like construction having an enlarged display screen for computing and telephone use. These devices are very sleek and have an attractive look, but are often difficult to rest in an upright position without the use of an external support or a third-party device cover. In use the device is held in one hand and presented to the user for interfacing with a second hand, or supported with both hands simultaneously. Input is received through a touchscreen interface or through physical keypad buttons along the front of the device.

Attempting to monitor the electronic device or make inputs when the device is not supported by hand becomes very difficult. This is particularly true when driving or when handling other objects in one's hands that would preclude personal handling of the electronic device. Most supports are device-specific and include connectors or attachments that are useful for one type of device. The present invention is provided to support a generic electronic device having a thin, substantially rectangular construction, whereby an elongated slot is provided to support the device in an upright configuration about the electronic device's lower edge.

Specifically, the present invention provides a support for a tablet, cell phone, or similar electronic device having either a touchscreen or physical buttons for entry. The device is positioned within a support slot that orients the device in an upright position such that the user can monitor the phone and make inputs without otherwise handling the device. The support can be positioned along a horizontal surface or alternatively can be supported along a vertical wall support by an upstanding back plate. In either embodiment, the support allows for temporary positioning of a smartphone or tablet device in an upstanding position while the user engages in other activities.

2. Description of the Prior Art

Devices have been disclosed in the prior art that relate to cell phone supports and charging devices. These include devices that have been patented and published in patent application publications, and generally relate to charging stations and cell phone cradles having a specific connector element for the electronic device. The following is a list of devices deemed most relevant to the present disclosure, which are herein described for the purposes of highlighting and differentiating the unique aspects of the present invention, and further highlighting the drawbacks existing in the prior art.

The devices in the prior art largely relate to handheld electronic device supports that are charging stations, whereby an electronic connection is achieved with the handheld device to recharge its battery while being supported. This requires an electrical connector that is unique to the device and a holder that supports the device in the necessary position to affect this connection.

U.S. Patent Publication No. 2009/0015198 to Brandenberg is one such device that discloses a docking and charging station for a portable electronic device having a structure that supports and electronically connects to the device. The charging station is equipped for either A/C or D/C charging, while the structure of the station includes an L-shaped device and a receptacle to accept the electronic device therein.

Similarly, U.S. Pat. No. 6,356,054 to Herrmann discloses another charging station that comprises a desktop stand for charging an electronic device and a spare battery in a simultaneous fashion. The device comprises a structure having a front and rear pocket for accepting a cell phone device and a spare battery therein, respectively. The device supports and charges the components, while supporting the cell phone in an upright configuration.

U.S. Pat. No. 7,108,437 to Silverbrook discloses another charging stand that supports a mobile telecommunications device, wherein the Silverbrook device accommodates those that have printing capabilities. The device includes a receptacle for supporting the mobile device, a power connection for powering the same, and an ink reservoir for refilling the ink within the mobile device for sustained printing capability.

U.S. Patent Publication No. 2011/0084651 to Caskey discloses yet another charging station for charging an electrical device, wherein the station comprises a housing, an electrical power plug, a power outlet, a universal serial bus connector, and a cradle for supporting the electrical device being charged. The charging station is connected to a power source and electrical power is relayed to a handheld electronic device, which is positioned within the cradle for support.

Finally, U.S. Patent Publication No. 2008/0012536 to Glass discloses a wall mounted charging station that is adapted for direct connection to a wall outlet, wherein a handheld electronic device is stored within a unique organizing apparatus while charging. The apparatus comprises a housing having a translucent cover, while an electrical cord enters the housing to charge the device cradled therewithin.

The devices of the prior art are limited to device-specific chargers or charging stations, whereby the primary goal is to recharge the device's battery. The present invention provides a generic electronic device stand that is adapted for use in an automobile or for use within the home or office. The device comprises a base having an upper slotted region, whereby a thin-shelled smartphone or tablet device can slide into the slotted upper for upright support. In this position, the user can monitor the device, observe the screen for reading or entertainment purposes, or the user can make inputs to the device via its interface without otherwise supporting the same.

It is submitted that the present invention is substantially divergent in design elements from the prior art, and consequently it is clear that there is a need in the art for an improvement to existing electronic device supports. In this regard the instant invention substantially fulfills these needs.

### SUMMARY OF THE INVENTION

In view of the foregoing disadvantages inherent in the known types of electronic device supports now present in the prior art, the present invention provides a new generic support for an electronic handheld device, wherein the same can be utilized for providing convenience for the user when supporting the handheld device in an upright configuration for use or for storage.

It is therefore an object of the present invention to provide a new and improved electronic device support that has all of the advantages of the prior art and none of the disadvantages.

It is another object of the present invention to provide an electronic device support that is adapted to provide a generic, non-brand specific cradle for an electronic device that requires no specific connectors or electrical connectivity to afford upstanding support therefor.

Another object of the present invention is to provide an electronic device support that includes a base and a slotted upper surface for supporting an electronic device in an upright configuration, whereby viewing the device and making inputs is accommodated.

Yet another object of the present invention is to provide an electronic device support that can be supported from below, such as on a desk or within a vehicle interior, or alternatively supported from a vertical surface, such as an interior wall.

Another object of the present invention is to provide an electronic device support that includes a weighted base to support larger and bulkier electronic devices without tipping and without consuming unnecessary surface area below the electronic device.

A final object of the present invention is to provide an electronic device support that may be readily fabricated from materials that permit relative economy for manufacturing and distribution that are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an embodiment of the present invention in which a weighted base is provided for supporting an electronic device in an upright configuration.

FIG. 2 shows another embodiment of the present invention in which a solid support is shown having a cross-wise slot across its body for supporting an electronic device in an upright configuration.

FIG. 3 shows an exemplary embodiment of the present invention, wherein a slotted support surface is provided and a vertical back plate allows the support to be mounted onto a vertical wall surface if desired.

### DETAILED DESCRIPTION OF THE INVENTION

Reference is made herein to the attached drawings. Like reference numerals are used throughout the drawings to depict like or similar elements of the electronic device support. For the purposes of presenting a brief and clear description of the present invention, the preferred embodiment will be discussed as used for providing a generic cradle for an electronic device such that the device is supported in a largely upstanding configuration. The figures are intended for representative purposes only and should not be considered to be limiting in any respect.

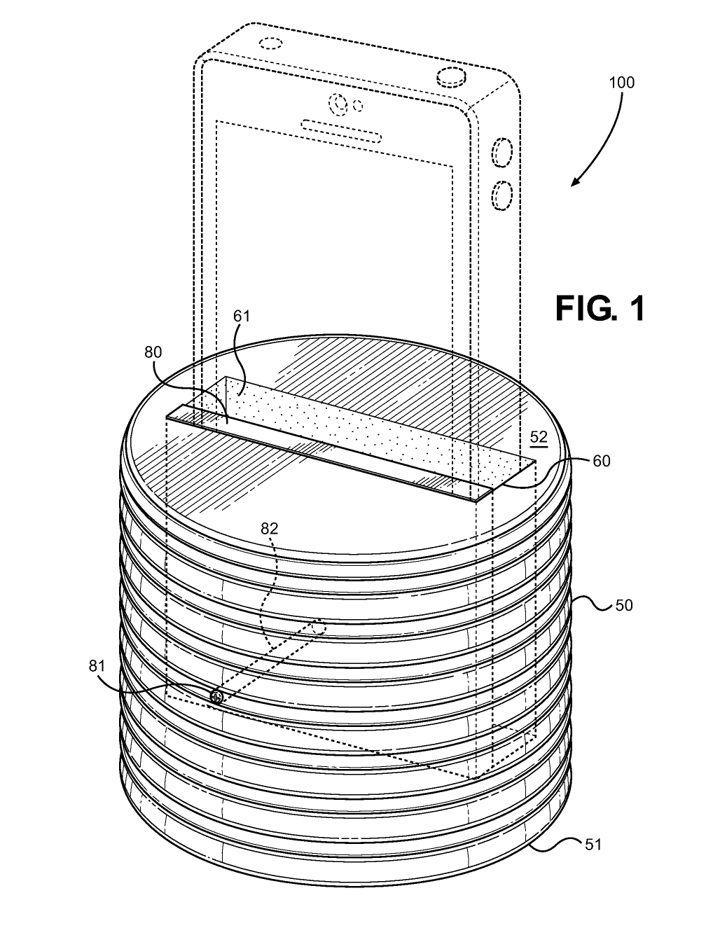

Referring now to FIG. 1, there is shown a perspective view of an embodiment of the electronic device support of the present invention, wherein the support comprises a weighted base 50 having an upper surface 52, a lower surface 51, and an upper slot 60 for engaging an electronic device 100 therein. The present invention is designed to accommodate electronic devices having a substantially rectangular shape, as is prevalent in the area of cellular phones, tablets, personal data assistants, and personal music players.

The support comprises a largely rectangular slot 60 having an open interior volume 61 that is larger than the cross sectional volume of the electronic device 100 such that the lower edge thereof can fit into the interior of the slot 60. The slot 60 engages the lower end or lower edge of the electronic device 100 such that the screen and body of the device is readily visible and accessible while being supported. At the same time, the slot 60 supports the device 100 in an upright and substantially vertical orientation. The slot 60 interior walls bear against the lower portion of the device 100 and prevent tipping, while the user can observe the device 100 screen and making inputs thereto if so desired.

In the embodiment as visualized in FIG. 1, the support comprises an upstanding body 50 having sidewalls and an enlarged height. This is but one configuration of the device, where different shapes and styles are contemplated. The base 50 is preferably a unitary material having sufficient density to provide a weighted support that does not readily tip over when engaged by a medium or large electronic device 100. Alternatively, the body 50 may include an open interior and a filler material that provides for a weighted support. This filler may be discrete weights or a granular weight filler material, as desired. The overall goal is to support the electronic device 100 in an upstanding configuration along a horizontal support surface without readily tipping, despite the electronic device 100 being extended far above the support and tipping otherwise being a concern.

To accommodate electronic devices 100 having different thicknesses while retaining them within the slot 60, a slot adjustment element 80 is provided that can be manipulated to change the width of the slot 60 for a more snug or loose support for the upright device 100. In a preferred embodiment, the adjustment element 80 is a member that articulates within the slot 60 interior by way of a set screw 81 through a conduit 82. The user adjusts the set screw 81, which drives the member 80 inward or retracts it from the slot 60 to adjust its width. Another embodiment for this element includes a padded interior slot that conforms to the exterior shape of the electronic device 100.

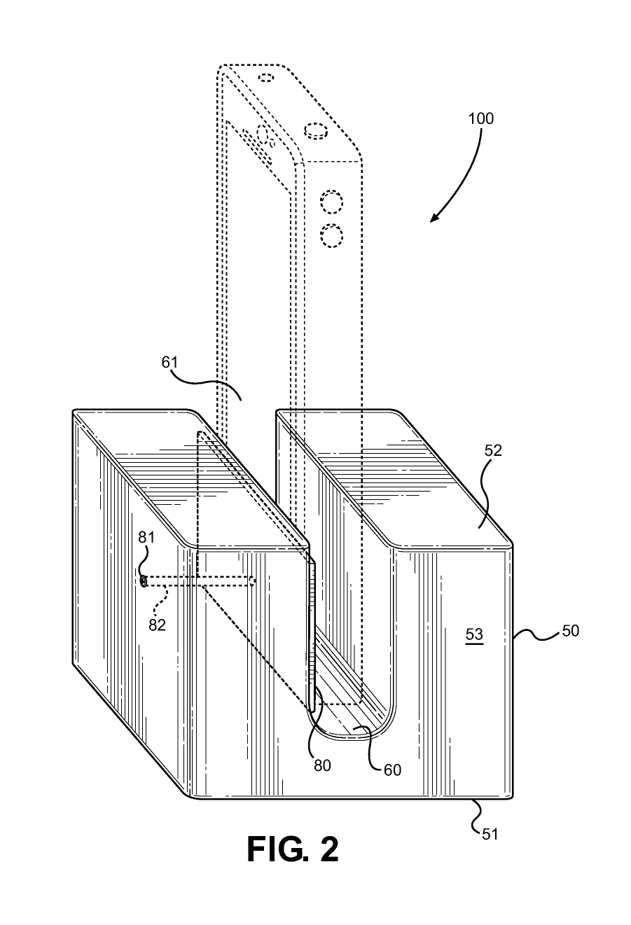

Referring now to FIG. 2, there is shown a second embodiment of the present electronic device support. This embodiment contemplates a body section 50 with an enlarged slot 60 that extends from one end of the body to the other. The slot 60 extends through the sidewalls 53 of the body 50 and includes an interior volume 61 suitable to accommodate the lower portion of a typical electronic device 100. Similar to the first embodiment, this embodiment includes an upper surface 52, a lower surface 51, a body section 50 and an elongated slot 60. The base surface 51 is sufficiently wide and the body section 50 is sufficiently weighted to prevent tipping when engaged with an upstanding electronic device 100. Similar to the first embodiment, the embodiment as shown in FIG. 2 includes an adjustment element 80, set screw 81 and conduit 82 for changing the width of the slot 60.

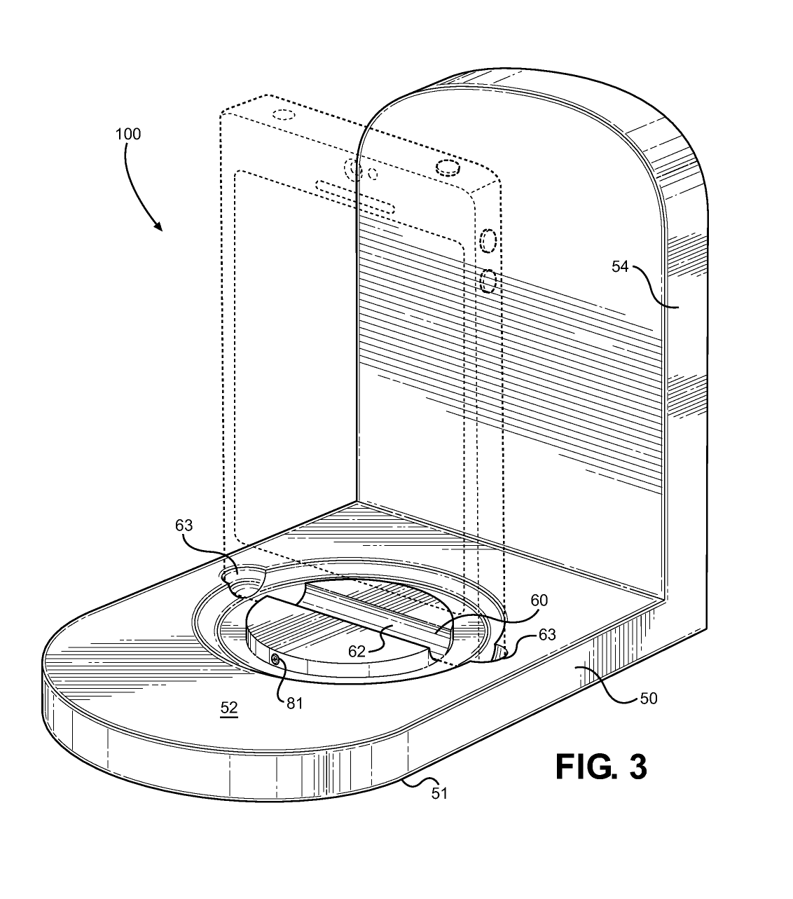

Referring now to FIG. 3, there is shown an exemplary embodiment of the electronic device support of the present invention. This embodiment contemplates a horizontal body section 50 supporting an electronic device 100 utilizing an elongated slot 60 along its upper surface 52, while also providing an upstanding back wall 54. The back wall 54 allows the support to be hung from a vertical wall, while the body section 50 allows the support to be placed on a horizontal support surface. Furthermore, the slot 60 of the exemplary embodiment may be partitioned, where an inner slot within a 62 supports smaller electronic devices 100 while outer slots 63 in alignment therewith accommodate larger, tablet-sized electronic devices 100. As with the previous embodiments, the width of the slot 60 can be adjusted by way of a set screw 81, which updates the width of the slot 60 for larger or smaller electronic devices.

Without a convenient place to store a cell phone, individuals can easily set their phone down somewhere and forget the location. They may miss important communications because they do not remember where they put their phone, or waste valuable time and energy searching for it. Also, shelves do not allow the cell phone to stand upright, making it difficult to see who is calling without going over to the phone and picking it up. Oftentimes, especially while driving, there is not a convenient location for storing the cell phone within easy reach. Individuals may not have a location to store various other items either, including key chains or clocks for convenient viewing.

The present invention provides an electronic device support stand or cradle. The device comprises a shelf having a slotted mount for positioning a mobile communication device, such as a cellular phone, in an upright position. This enables a user to view the screen while the phone is on the stand in order to determine who an incoming phone call is from. The device provides a user with a consistent place for setting his or her cell phone, thereby preventing users from misplacing their phone, and saving the time and energy that would otherwise be spent looking for it.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electronic device support, comprising:
a body section having an upper surface, a lower surface, and sidewalls;
said upper surface having an elongated slot having an interior volume adapted to accept a substantially rectangular electronic device lower portion thereinto and adapted to support said electronic device in a substantially upright configuration;
said body section having a weight adapted to prevent tipping while engaged with an electronic device.

2) The device of claim 1, wherein said slot extends along said body section from one sidewall to an opposing sidewall.

3) The device of claim 1, wherein said body section further comprises an upstanding back wall adapted to allow mounting said body section against a wall surface.

4) The device of claim 1, wherein said slot is adjustable in width.

5) The device of claim 4, wherein said adjustment comprises a movable member supported within said slot that can be adjusted therein by way of a set screw.
